(19) United States
(12) Patent Application Publication
(10) Pub. No.: US 2016/0227015 A1
(43) Pub. Date: Aug. 4, 2016

(54) METHOD, APPARATUS AND MOBILE TERMINAL FOR SPEED DIAL WITHIN PAGE

(71) Applicant: Alibaba Group Holding Limited, Grand Cayman (KY)

(72) Inventor: Di Fan, Hangzhou (CN)

(21) Appl. No.: 15/008,349

(22) Filed: Jan. 27, 2016

(30) Foreign Application Priority Data
Feb. 3, 2015 (CN) 201510056148.1

(51) Int. Cl. H04M 1/725; G06T 11/60; G06F 3/0488; G06F 3/0484; H04M 3/44; G06K 9/00

(52) U.S. Cl. CPC H04M 1/72519; H04M 3/44; H04M 1/7258; G06K 9/00422; G06F 3/04883; G06F 3/04847; G06T 11/60

(57) ABSTRACT

A method for speed dial is disclosed. The method includes generating a transparent or semitransparent mask layer on a region of a currently displayed page according to a designated trigger instruction; obtaining input information of a user on the mask layer; determining dial information according to the input information; and dialing a number according to the dial information. The present disclosure further provides a dial apparatus and a mobile terminal for speed dial correspondingly. The present disclosure is able to implement speed dial without exiting a page that is currently browsed, thus being more convenient in use and improving user experience.

### CROSS REFERENCE TO RELATED PATENT APPLICATION

This application claims foreign priority to Chinese Patent Application No. 201510056148.1 filed on Feb. 3, 2015, entitled “Method, Apparatus and Mobile Terminal for Speed Dial within Page”, which is hereby incorporated by reference in its entirety.

### TECHNICAL FIELD

The present disclosure relates to the field of mobile communication technologies, and in particular, to methods, apparatuses, and mobile terminals for speed dial within a page.

### BACKGROUND

Along with the intellectualization of mobile terminals and the development of application software, an increasing number of users like to conduct web browsing and shopping using mobile terminals. A user may conduct web browsing or shopping using browser software or other third-party application software, such as Taobao™, that is installed in a mobile terminal.

For example, when a user browses products on a shopping web page using an application software such as a Taobao™ client and wants to make a phone call, the user first needs to press a home key of a mobile terminal to return to a front screen from a browsing interface of a current web page. The user then selects and clicks a phone icon on the front screen to enter a dial interface, clicks numerals in the dial interface to input a phone number, and finally clicks a dial button to perform dialing. FIGS. 1-3 show schematic diagrams of a dialing method when browsing a page under existing technologies. FIG. 1 is a schematic diagram showing a user browsing a web page product through a Taobao™ client in existing technologies. FIG. 2 is a schematic diagram showing the user pressing a home key of a mobile terminal to return to a front screen from a browsing interface in the existing technologies. FIG. 3 is a schematic diagram showing the user entering a phone number on a dial interface that is displayed after a phone icon is clicked in the existing technologies.

As can be seen from the above dialing process in the existing technologies, if a user intends to make a phone call during web browsing or shopping, the user cannot directly dial from the currently browsed page. Rather, the user needs to exit from the currently browsed page to a screen containing a phone icon, and perform dialing by clicking the phone icon. This operation process involves a relative large number of steps, and dialing is inconvenient. Furthermore, if a previously browsed page is to be returned to after the dialing, the web page needs to be reopened, thus bringing inconvenience to browsing and affecting browsing or shopping experience.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

In view of the above, the present disclosure provides a method, an apparatus and a mobile terminal for speed dial-up from within a page, which can implement speed dial without exiting a currently browsed page, thereby being more convenient in use and improving user experience.

Technical solutions provided in the present disclosure are given as follows.

According to an aspect of the present disclosure, an in-page speed dial method is provided, which may include generating a transparent or semitransparent mask layer on a region of a currently displayed page according to a designated trigger instruction; obtaining input information of a user on the mask layer; determining dial information based on the input information; and performing a dialing based on the dial information.

In implementations, the mask layer may include a div layer, and the div layer covers at least a portion of the region of the currently displayed page.

In implementations, performing the dialing based on the dial information may include invoking a dialing program interface of a system, and sending the dial information to the dialing program interface to perform the dialing.

In implementations, generating the transparent or semitransparent mask layer on the currently displayed page region according to the designated trigger instruction may include setting the at least portion of the region of the page to be visible.

In implementations, the designated trigger instruction may include a set function key of a mobile terminal being pressed for a set time length.

In implementations, obtaining the input information of the user on the mask layer may include receiving handwriting input content on the mask layer. Furthermore, determining the dial information based on the input information may include invoking a handwriting recognition program to recognize the input content to obtain the dial information. Additionally or alternatively, obtaining the input information of the user on the mask layer may include displaying numerical symbols on the mask layer, and receiving clicks on the numerical symbols on the mask layer. Furthermore, determining the dial information based on the input information may include obtaining the dial information based on the clicks on the numerical symbols. Additionally or alternatively, obtaining the input information of the user on the mask layer may include displaying a dial interface invoked by a set interface on the mask layer, and receiving the clicks on the numerical symbols on the dial interface, the dial interface covering at least the partial region of the currently displayed page. Furthermore, determining the dial information based on the input information may include obtaining the dial information based on the clicks on the numerical symbols.

In implementations, the mask layer may further include generating and displaying a dial button.

In implementations, the mask layer may further include displaying content used for prompting numbers inputted for dialing, and/or canceling displaying of the content used for prompting the numbers inputted for dialing.

In implementations, the page may include a web page.

According to another aspect of the present disclosure, an in-page speed dial apparatus is provided, which may include a generation unit to generate a transparent or semitransparent mask layer on a region of a currently displayed page according to a designated trigger instruction; an information acquisition unit to obtain input information of a user on the mask layer that is generated by the generation unit; an information determination unit to determine dial information based on the input information that is obtained by the information acquisition unit; and a dial unit to dial according to the dial information that is determined by the information determination unit.

In implementations, at least partial portion of the region of the page is set to be visible when the transparent or semitransparent mask layer on the currently displayed page region is generated according to the designated trigger instruction.

In implementations, the information acquisition unit may include a first acquisition unit to receive handwriting input content on the mask layer, and the information determination unit may include a first determination unit to invoke a handwriting recognition program to recognize the input content to obtain the dial information. Additionally or alternatively, the information acquisition unit may include a second acquisition unit to display numerical symbols on the mask layer and receive clicks on the numerical symbols on the mask layer, and the information determination unit may include a second determination unit to obtain the dial information based on the clicks on the numerical symbols. Additionally or alternatively, the information acquisition unit may include a third acquisition unit to display a dial interface invoked by a set interface on the mask layer and receive the clicks on the numerical symbols on the dial interface, where the dial interface covers at least the partial region of the currently displayed page. Furthermore, the information determination unit may include a third determination unit to obtain the dial information based on the clicks on the numerical symbols.

In implementations, the apparatus may further include a dial prompt unit to generate and display a dial button on the mask layer.

In implementations, the apparatus may further include a content prompting unit to display on the mask layer content used for prompting numbers inputted for dialing and/or cancel displaying of the content used for prompting the numbers inputted for dialing.

According to another aspect of the present disclosure, a mobile terminal is provided, which may include the in-page speed dial apparatus as described above.

As can be seen from the aforementioned technical solutions, a transparent or semitransparent mask layer is generated on a currently displayed page region according to a designated trigger instruction in the present disclosure. If a user wants to make a phone call, the user may directly input information on the mask layer. A system may then determine dial information based on the input information. In this case, an originally browsed page is not affected, and dialing is achieved based on the dial information. Operation procedure is therefore much easier than the dialing method of the existing technologies, and speed dial can be implemented without exiting a currently browsed page, thus being more convenient in use and improving user experience.

In order to implement the above and related objectives, one or more aspects of the present disclosure may include features recited in the appended claims, which are described in detail hereinafter. Some exemplary aspects of the present disclosure are described in following descriptions and accompanying drawings in detail. However, these aspects merely represent a portion of a variety of different approaches that are able to employ the principles of the present disclosure. Moreover, the present disclosure intends to cover all these aspects and equivalents thereof.

### BRIEF DESCRIPTION OF THE DRAWINGS

In order to explain the technical solutions of the embodiments of the present disclosure more clearly, the accompanying drawings that are used for describing the embodiments are briefly described herein. Apparently, the described drawings merely represent some embodiments of the present disclosure. Based on these drawings, one of ordinary skill in the art can obtain other drawings without making any creative effort.

FIG. 1 is a schematic diagram showing a user browsing a web page product through a Taobao™ client terminal under existing technologies.

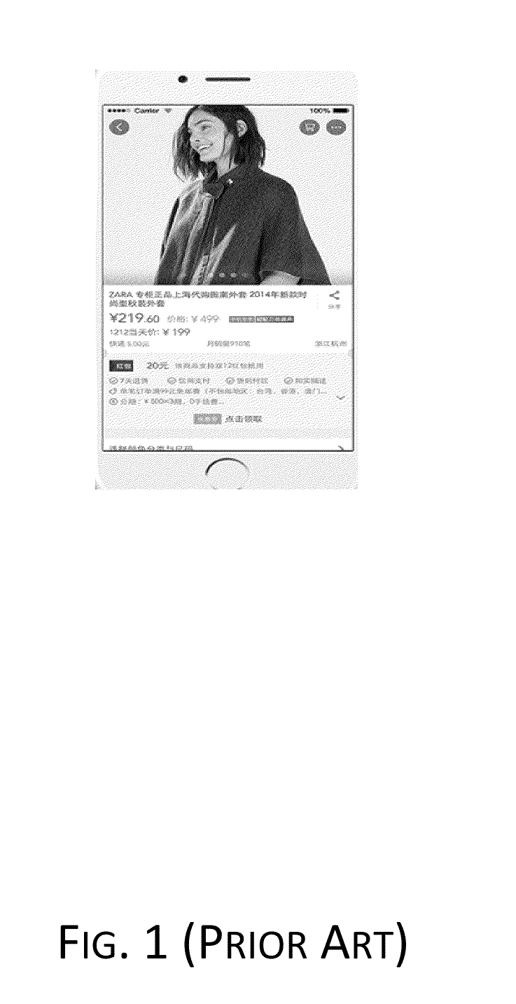

FIG. 2 is a schematic diagram showing the user pressing a home key of a mobile terminal to return to a front screen from a browsing interface in existing technologies.

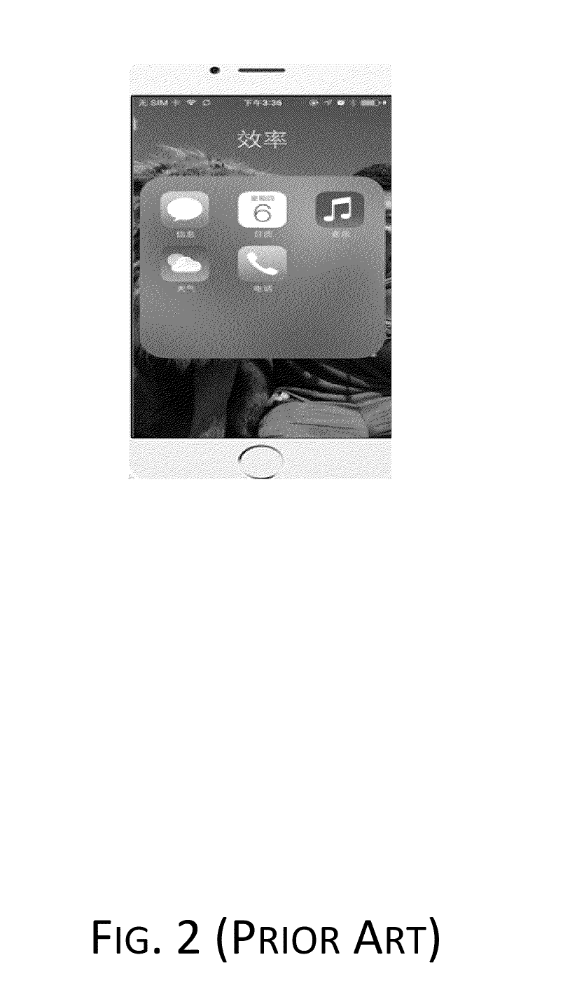

FIG. 3 is a schematic diagram showing the user inputting a phone number on a dial interface displayed after a phone icon is clicked in existing technologies.

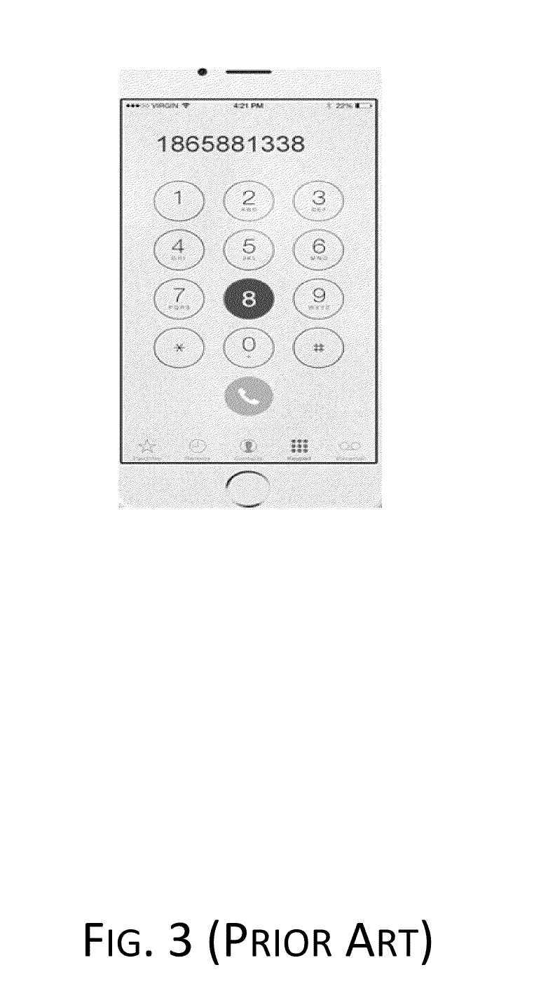

FIG. 4 is a first flowchart of an in-page speed dial method according to the present disclosure.

FIG. 5 is a second flowchart of an in-page speed dial method according to the present disclosure.

FIG. 6 is a third flowchart of an in-page speed dial method according to the present disclosure.

FIG. 7 is a schematic diagram of in-page speed dial according to the present disclosure.

FIG. 8 is a first structural diagram of a speed dial apparatus according to the present disclosure.

FIG. 9 is a second structural diagram of a speed dial apparatus according to the present disclosure.

FIG. 10 is a structural diagram of a mobile terminal according to the present disclosure.

### DETAILED DESCRIPTION

In order to make objectives, features and advantages of the present disclosure to be more clear and comprehensible, the technical solutions in the embodiments of the present disclosure are described herein in conjunction with the accompanying drawings in the embodiments of the present disclosure. Apparently, the described embodiments merely represent a part of and not all of the embodiments of the present disclosure. Based on the embodiments of the present disclosure, all other embodiments obtained by one of ordinary skill in the art without making any creative effort shall fall in the scope of protection of the present disclosure.

The present disclosure provides an in-page speed dial method that is able to achieve a speed dial without exiting a currently browsed page, which is more convenient in use and improves user experience.

The embodiments of the present disclosure are described with reference to the accompanying drawings hereinafter.

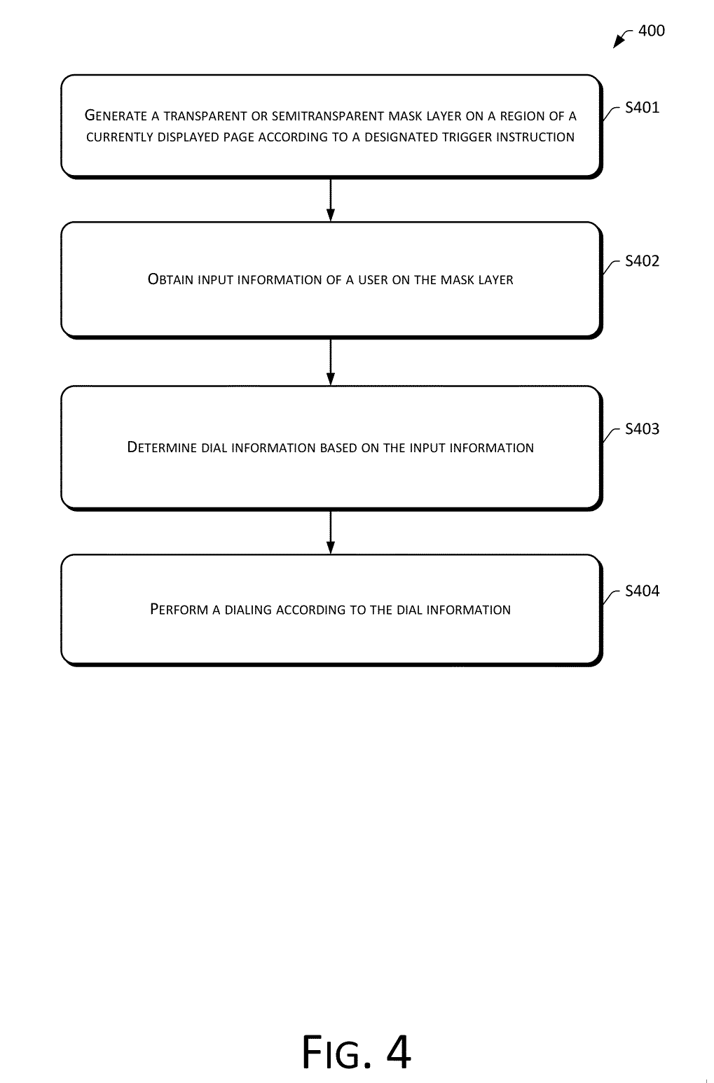

FIG. 4 shows a first flowchart of an in-page speed dial method 400 according to the present disclosure. As shown in FIG. 4, the method 400 may include the following method blocks.

S401 generates a transparent or semitransparent mask layer on a region of a currently displayed page according to a designated trigger instruction.

In implementations, the mask layer may be a div (division) layer, and the div layer may cover at least a portion of the region of the currently displayed page.

In implementations, this method block may include setting the at least a portion of the region of the page to be visible.

In implementations, the designated trigger instruction may include a set function key of a mobile terminal being pressed for a set time length.

In implementations, the page may include a web page.

S402 obtains input information of a user on the mask layer.

S403 determines dial information based on the input information.

S404 performs a dialing according to the dial information.

This method block may invoke a dialing program interface of a system, and send the dial information to the dialing program interface for dialing.

In implementation, the method blocks S402 and S403 may include processing methods as described in the following.

In implementations, obtaining the input information of the user on the mask layer may include receiving handwriting input content on the mask layer, and determining the dial information based on the input information may include invoking a handwriting recognition program to recognize the input content to obtain the dial information.

Additionally or alternatively, obtaining the input information of the user on the mask layer may include displaying numerical symbols on the mask layer and receiving clicks on the numerical symbols on the mask layer, and determining dial information based on the input information may include obtaining the dial information based on the clicks on the numerical symbols.

Additionally or alternatively, obtaining the input information of the user on the mask layer may include displaying a dial interface invoked by a set interface on the mask layer, and receiving the clicks on the numerical symbols on the dial interface, where the dial interface covers at least the partial region of the currently displayed page. Furthermore, determining the dial information based on the input information may include obtaining the dial information based on the clicks on the numerical symbols.

As can be seen from the aforementioned technical solutions, a transparent or semitransparent mask layer is generated on a currently displayed page region according to a designated trigger instruction in the present disclosure. If a user wants to make a phone call, the user may directly input information on the mask layer. A system may then determine dial information based on the input information. In this case, an originally browsed page is not affected, and dialing is achieved based on the dial information. Operation procedure is therefore much easier than the dialing method of the existing technologies, and speed dial can be implemented without exiting a currently browsed page, thus being more convenient in use and improving user experience.

Technical solutions of the present disclosure are described in further details hereinafter.

A technical solution is described using, but is not limited to, an example scenario of dialing a phone number when a shopping page is browsed via a Taobao™ client. A scenario of dialing a phone number when browsing a web page such as browsing news via a browser is similar thereto.

A dialing method provided in the present disclosure is different from the dialing method of existing technologies. In the solution of the present disclosure, if a user desires to make a phone call, for example, make a phone call to a family member when shopping via a Taobao™ client, only a long press on a lock-screen key for one to two seconds is needed on a page that is currently browsed for shopping. Dialing may be achieved after dial information such as a numerical number is written directly by gesture(s) on a mask layer that is generated on a screen, without the need of exiting the current page to click a phone icon to enter a dial interface for inputting numbers, thus being more convenient in use and more favored by users.

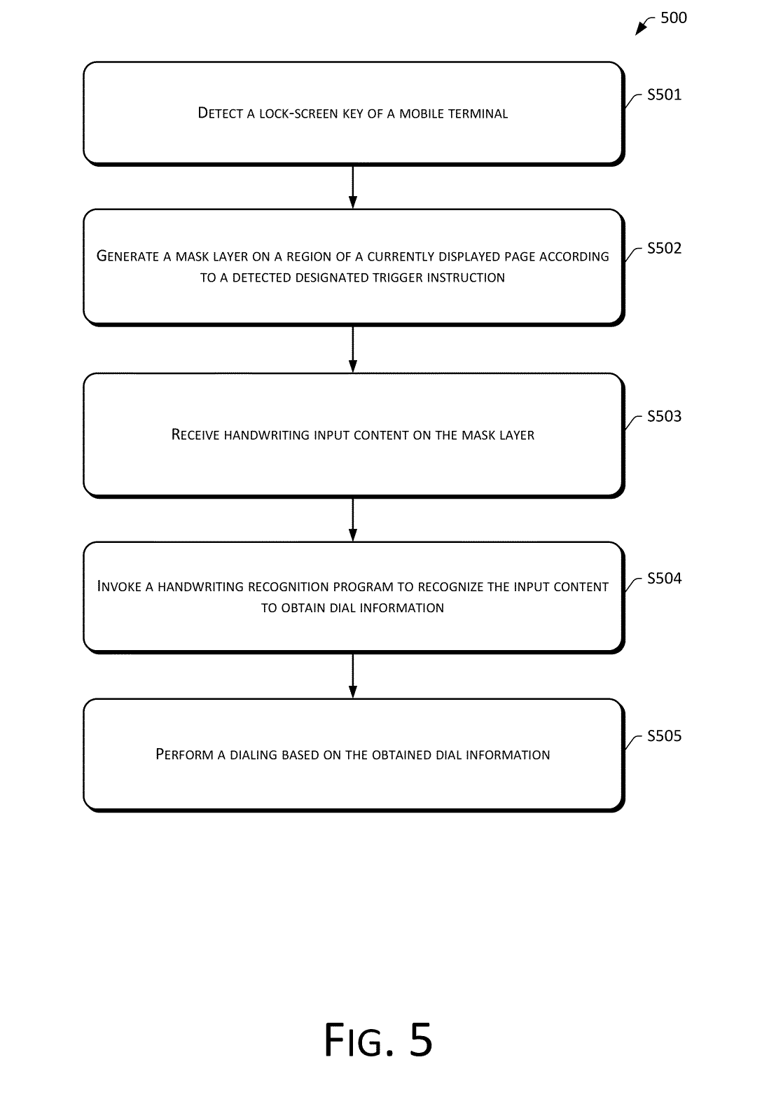

FIG. 5 is a second flowchart of an in-page speed dial method 500 according to the present disclosure. More details of a handling process thereof is given as compared with FIG. 4.

As shown in FIG. 5, the method 500 may include the following method blocks.

S501 detects a lock-screen key of a mobile terminal.

This method block may configure a dedicated program for monitoring whether a set function key is pressed and recording a time length of such pressing. In an embodiment, the set function key may include, but not limited to, a screen-lock key, for example, or other function keys, such as a volume key or other keys, etc.

Positions of lock-screen keys of mobile terminals may vary across different terminals, e.g., may be located at a right-hand frame of a mobile terminal, or may be located at an upper frame of a mobile terminal, which is not limited in the present disclosure.

S502 generates a mask layer on a region of a currently displayed page according to a detected designated trigger instruction.

In this method block, the detected designated trigger instruction may include a detection of a set function key, such as a lock-screen key, of a mobile terminal being pressed for a set time length.

In this method block, the set time length may be one to two seconds. In other words, in response to detecting that the lock-screen key of the mobile terminal has been persistently pressed for one to two seconds, a mask layer is generated on a region of a currently displayed page of the mobile terminal. The generation of the mask layer may be implemented using a conventional mask technology. In implementations, the mask layer may include a div layer, and the div layer may cover at least a portion of the region of the currently displayed page. As the mask layer is generated, isolation is formed from an originally browsed page, and therefore, the browsed page is not affected by operations on the mask layer.

In this method block, the mask layer may be a transparent or semitransparent mask layer, and may additionally or alternatively be set to other colors based on configuration.

In implementations, this method block of generating the transparent or semitransparent mask layer may further include setting the at least portion of the region of the page to be visible.

Moreover, content used for prompting numbers that may be dialed may further be displayed on the mask layer, for example, a text prompt of “Dialing may be performed by handwriting numbers”, and specific prompt content may be configured according to needs.

A lock-screen key of a mobile terminal generally has the following functions. First, upon being pressed only once, a background program of the mobile terminal determines such pressing as a lock-screen command, a time length of this pressing is generally configured as not longer than one second, and the background program activate a lock-screen function after determining that this is the lock-screen command. Second, on a basis of the foregoing first action, after being pressed once more, the background program may determine that such action is a screen start command, with a time length of such pressing being generally set to be not longer than one second, and the background program enables a screen callout function after in response to determining that this is the screen start command. Third, when a time length of a persistent pressing of the lock-screen key exceeds three seconds, the background program may determine that a user needs to shut down the mobile terminal, and a default shutdown interface of a system appears for further confirmation.

Therefore, based on existing functions of a lock-screen key, the present disclosure provides a method that does not conflict with the existing functions, and defines a persistent pressing of the lock-screen key for one to two seconds as a trigger signal for a new function. This new function is used cooperatively with other operations, thereby achieving an objective of speed dial.

It should be noted that the lock-screen key is set to be pressed for one to two seconds to avoid conflicts with original functions. If another function key is selected, a similar time length may be configured, provided that a newly set time length does not conflict with original functions thereof. For example, a persistent pressing of a volume key for one to two seconds may also be set as a trigger signal for a new function.

S503 receives handwriting input content on the mask layer.

After observing that the mask layer appears on the currently browsed page, the user may directly input information, for example, content such as numbers, on the mask layer by handwriting, and a system of the mobile terminal may receive the content such as the handwriting numbers inputted on the mask layer.

S504 invokes a handwriting recognition program to recognize the input content to obtain dial information.

The system of the mobile terminal invokes a handwriting recognition program installed in the mobile terminal to perform recognition of the input content.

In implementations, the system of the mobile terminal may transmit a trajectory of an operation gesture received from the user, i.e., the handwriting content, to a handwriting recognition program of a gesture recognizer of the mobile terminal for the handwriting recognition program to perform recognition. A mobile terminal generally includes a handwriting recognition program.

The handwriting recognition program may determine the closest number based on a degree of similarity with the gesture. In implementations, a determination may be made for the input content based on the most similar pattern from among numbers 0, 1, 2, 3, 4, 5, 6, 7, 8 and 9. By way of examples, a determination may be made that the input content is a corresponding number to which number pattern is the most similar. For example, 8 is handwritten, the handwriting recognition program may recognize that a handwritten pattern thereof has a degree of similarity of more than 98% with a pattern of number 8, and therefore determines that the number 8 is handwritten. It should be noted that a similarity degree threshold may be set up during the determination, and a corresponding number is determined when the threshold is exceeded thereby. In addition, if the user writes unrecognizable content by hand, the system of the mobile terminal may invoke a keypad to enable the user to select a numeral from among 0 to 9, and display the numeral on a dial region as a prompt.

S505 performs a dialing based on the obtained dial information.

This method block may conduct a dialing directly based on the obtained dial information.

Furthermore, this method block may generate and display a dial button on the mask layer. Therefore, the user may click the dial button, and the system of the mobile terminal may conduct a dialing based on the obtained dial information in response to detecting that the dial button is clicked.

In addition, after the dial information is obtained, if content has been prompted when numerals are handwritten previously, displaying of the content used for prompting numerals may be inputted for dialing may be canceled.

As can be seen from the above process, in the solution of the present embodiment, if a user intends to make a phone call during shopping, the user does not need to exit a currently browsed page, and may directly press a lock-screen key of a mobile terminal for one to two seconds, for example, on the currently browsed page. A faster and more convenient dialing can be implemented after a numeral number is written via gesture(s) directly on a mask layer generated on a screen.

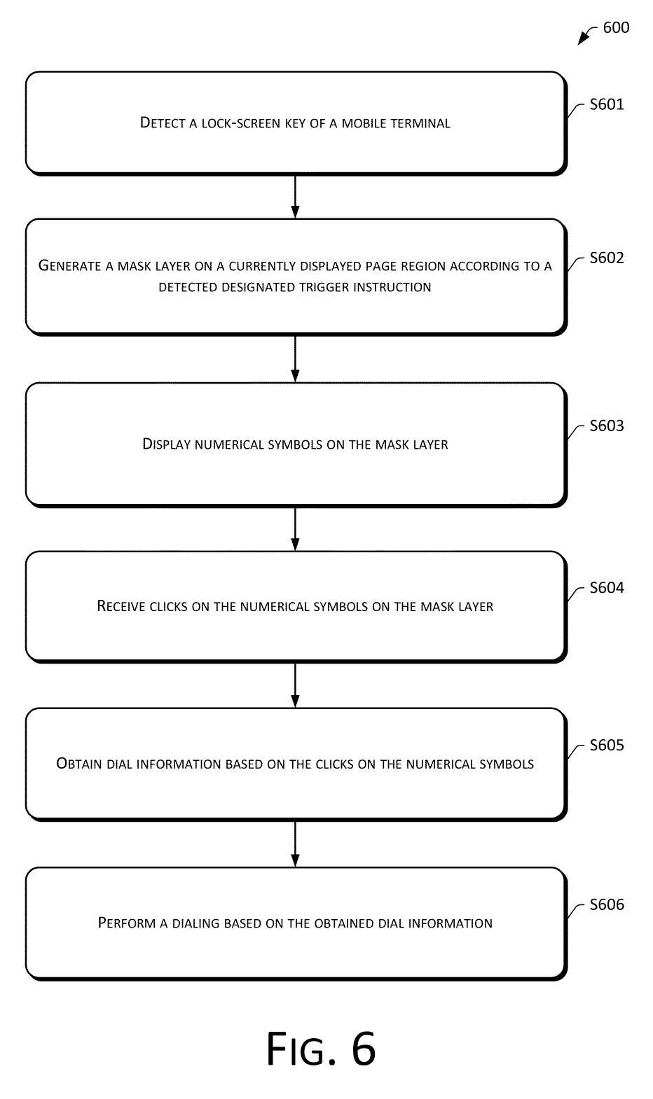

FIG. 6 is a third flowchart of an in-page speed dial method 600 according to the present disclosure. Compared with FIG. 5, an approach of obtaining dial information is slightly different in FIG. 6. In FIG. 5, the dial information is obtained from handwriting numerals, and the dial information is obtained by clicking numerals in FIG. 6.

As shown in FIG. 6, the method 600 may include the following method blocks.

S601 detects a lock-screen key of a mobile terminal.

This method block is the same as S501, and is not redundantly described herein.

S602 generates a mask layer on a currently displayed page region according to a detected designated trigger instruction.

This method block is the same as S502, and is not redundantly described herein.

S603 displays numerical symbols on the mask layer.

After the mask layer is generated, the present embodiment may further display numerical symbols on the mask layer for a user to click and select. The numerical symbols may be directly displayed as number keys of 0-9. Alternatively, a keypad that is installed a system of the mobile terminal may be invoked, with the keypad displaying numerals 0-9.

S604 receives clicks on the numerical symbols on the mask layer.

In this method block, the system of the mobile terminal receives the clicks on the numerical symbols. If number keys of 0-9 are directly displayed in the previous method block, the clicks on the number keys are received. If a keypad is invoked in the previous method block, the clicks on the keypad are received.

S605 obtains dial information based on the clicks on the numerical symbols.

In this method block, dial information such as a phone number may be obtained directly according to the numerical symbols clicked by the user. Therefore, handwritten numerals are not needed in the present embodiment. This method block also does not need to invoke a gesture recognition program to recognize the handwritten numerals.

S606 performs a dialing based on the obtained dial information.

This method block may conduct dialing directly based on the obtained dial information.

Furthermore, this method block may generate and display a dial button on the mask layer. The user may therefore click the dial button, and the system of the mobile terminal may then dial a number according to the obtained dial information in response to detecting that the dial button is clicked.

In addition, after the dial information is obtained, if content has been previously prompted, displaying of the content used for prompting the numerals that may be inputted for dialing may be canceled.

As can be seen from the above process, in the solution of the present embodiment, if a user intends to make a phone call during shopping, the user does not need to exit a currently browsed page, and may directly press a lock-screen key of a mobile terminal for one to two seconds, for example, on the currently browsed page. A faster and more convenient dialing can be implemented after directly clicking multiple numerical symbols from among a plurality of numerical symbols displayed on a mask layer that is generated on a screen.

It should be further noted that, a third approach may additionally or alternatively be used for obtaining a phone number inputted on a mask layer in the present disclosure.

Specifically, a dial interface invoked by a set interface is displayed on a mask layer, and clicks on numerical symbols on the dial interface are received. The dial interface covers at least a partial region of a currently displayed page, and a phone number is obtained according to the clicks on the numerical symbols. In other words, in a situation that interface(s) is/are opened, an interface for dialing a number may be directly invoked when an original web page is displayed, and numerals of a phone number may be directly selected and inputted in the dial interface without the need and cooperation of handwriting.

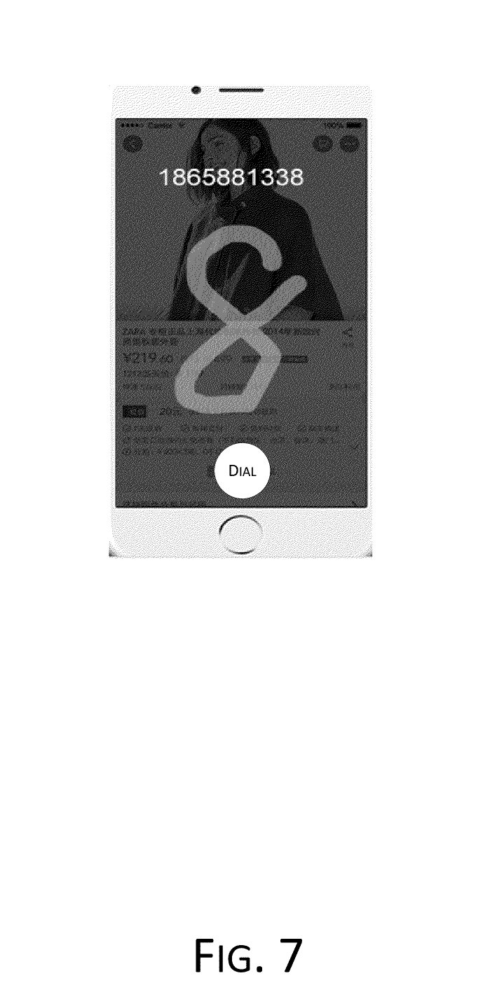

In order to understand the solution of the present disclosure in a more intuitive way, a schematic diagram of directly dialing in a browsed page in accordance with the present disclosure is shown in FIG. 7. As shown in FIG. 7, a mask layer is generated in a browser page to isolate a currently browsed page. After a user completes entering a phone number by handwriting, a dial button is displayed at the lower portion of the mask layer, and the user may click the dial button to implement direct dialing, which is simpler and more convenient as compared with the existing technologies.

A method flow of the present disclosure is described in detail above. Correspondingly, the present disclosure provides an apparatus and a mobile terminal for speed dial.

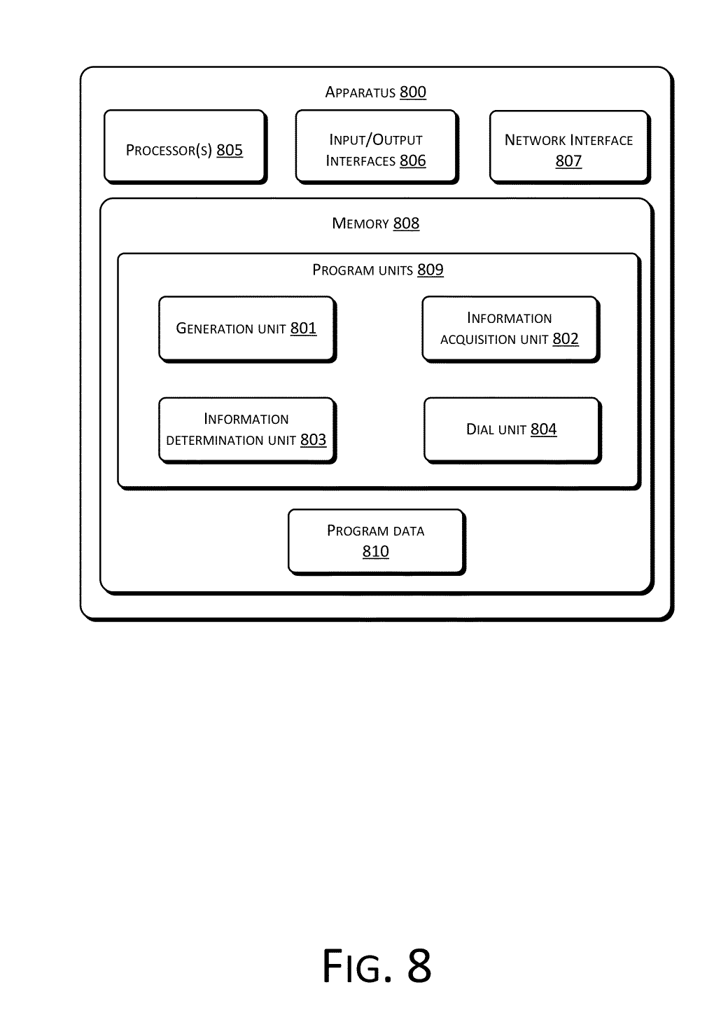

FIG. 8 is a first structural diagram of a speed dial apparatus 800 according to the present disclosure.

As shown in FIG. 8, an in-page speed dial apparatus 800 may include a generation unit 801, an information acquisition unit 802, an information determination unit 803 and a dial unit 804.

The generation unit 801 generates a transparent or semitransparent mask layer on a currently displayed page region according to a designated trigger instruction.

In implementations, when generating the transparent or semitransparent mask layer on the currently displayed page region according to the designated trigger instruction, the generation unit 801 may set at least a partial region of the page to be visible.

In implementations, the designated trigger instruction may include a set function key of a mobile terminal being pressed for a set time length. The function key may be, for example, a lock-screen key, a volume key, and the like. The set time length may be, for example, one to two seconds, etc.

In implementations, the page may be a web page.

The information acquisition unit 802 obtains input information of a user on the mask layer that is generated by the generation unit 801.

The information determination unit 803 determines dial information based on the input information that is obtained by the information acquisition unit 802.

The dial unit 804 dials a number based on the dial information that is determined by the information determination unit 803.

In implementations, the apparatus 800 may include one or more computing devices. By way of example and not limitation, the apparatus 800 may include one or more processors 805, an input/output (I/O) interface 806, a network interface 807 and memory 808.

The memory 808 may include a form of computer readable media, e.g., a non-permanent storage device, random-access memory (RAM) and/or a nonvolatile internal storage, such as read-only memory (ROM) or flash RAM. The memory 808 is an example of computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The memory 808 may include program units 809 and program data 810. The program units 810 may include the generation unit 801, the information acquisition unit 802, the information determination unit 803 and the dial unit 804.

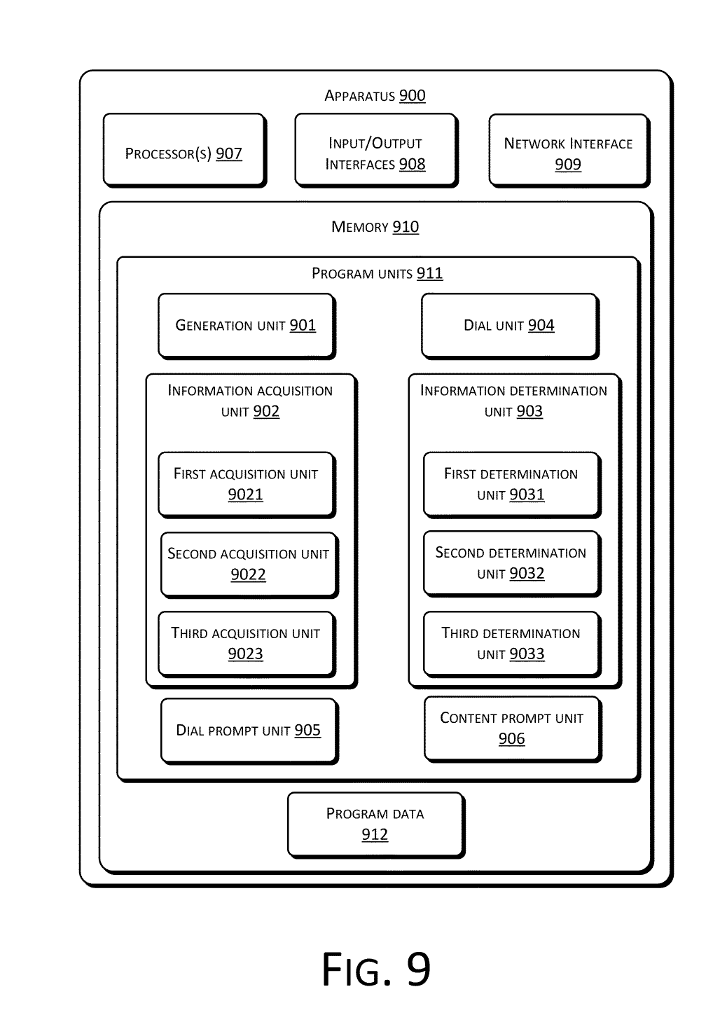

FIG. 9 is a second structural diagram of a speed dial apparatus 900 according to the present disclosure.

As shown in FIG. 9, an in-page speed dial apparatus 900 may include a generation unit 901, an information acquisition unit 902, an information determination unit 903, and a dial unit 904. Functions of these units are the same as the functions of the units as shown in FIG. 8.

Furthermore, the information acquisition unit 902 may include a first acquisition unit 9021 to receive handwriting input content on the mask layer. The information determination unit 903 may include a first determination unit 9031 to invoke a handwriting recognition program to recognize the input content to obtain the dial information.

Additionally or alternatively, the information acquisition unit 902 may include a second acquisition unit 9022 to display numerical symbols on the mask layer, and receive clicks on the numerical symbols on the mask layer. The information determination unit 903 may include a second determination unit 9032 to obtain the dial information according to the clicks on the numerical symbols.

Additionally or alternatively, the information acquisition unit 902 may include a third acquisition unit 9023 to display a dial interface invoked by a set interface on the mask layer, and receive the clicks on the numerical symbols on the dial interface, where the dial interface covers at least a partial region of a currently displayed page. The information determination unit 903 may include a third determination unit 9033 to obtain the dial information based on the clicks on the numerical symbols.

In implementations, the apparatus 900 may further include a dial prompt unit 905 to generate and display a dial button on the mask layer.

In implementations, the apparatus 900 may further include a content prompt unit 906 to display content used for prompting for numbers that may be inputted for dialing and/or cancel displaying of the content used for prompting for the numbers that may be inputted for dialing. For example, a text prompt of “dialing may be performed by handwriting numbers”, and specific prompt content may be set according to needs.

In implementations, the apparatus 900 may include one or more processors 907, an I/O interface 908, a network interface 909 and memory 910. The memory 910 may include a form of computer readable media, e.g., a non-permanent storage device, random-access memory (RAM) and/or a nonvolatile internal storage, such as read-only memory (ROM) or flash RAM. The memory 910 is an example of computer readable media as described in the foregoing description. In implementations, the memory 910 may include program units 911 and program data 912. The program units may include one or more of the generation unit 901, the information acquisition unit 902 (the first acquisition unit 9021, the second acquisition unit 9022 and the third acquisition unit 9023), the information determination unit 903 (which may include one or more of the first determination unit 9031, the second determination unit 9032 and the third determination unit 9033), the dial unit 904, the dial prompt unit 905 and the content prompt unit 906.

Interaction relationships among the units may be obtained with reference to the description of the previous method flowcharts, and are not repeatedly described herein.

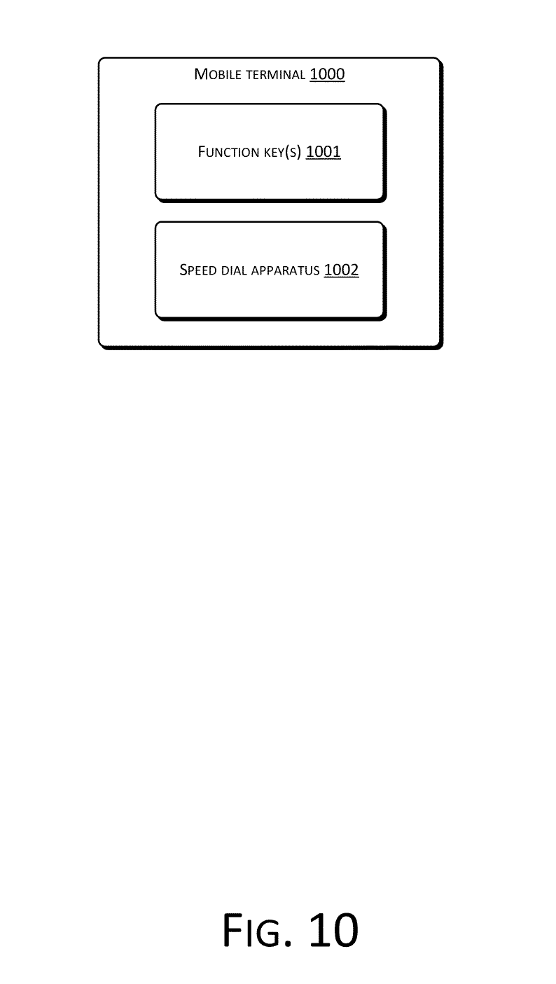

FIG. 10 is a structural diagram of a mobile terminal according to the present disclosure. As shown in FIG. 10, a mobile terminal 1000 may include one or more function key(s) 1001 disposed in the mobile terminal 1000, and may further include an in-page speed dial apparatus 1002. A structure of the speed dial apparatus 1002 may be obtained by referring to the structure and description as shown in FIG. 8 and FIG. 9, and is not repeatedly described herein.

It should be noted that a plurality of function keys 1001 of the mobile terminal 1000 may exist, and the function keys may include, for example, a lock-screen key, a volume key, etc.

In view of the above, the present disclosure generates a transparent or semitransparent mask layer on a currently displayed page region according to a designated trigger instruction. If a user intends to make a phone call, the user may directly input information on the mask layer. A system may then determine dial information based on the input information. In this case, an originally browsed page is not affected, and dialing may be implemented according to the dial information. In this way, the operation procedure is easier than the dialing method of existing technologies, and speed dial can be implemented without exiting a currently browsed page, which is more convenient in use and improves user experience.

Moreover, a mobile terminal described in the present disclosure may typically include a variety of handhold terminal devices having a Bluetooth function such as a mobile phone having a Bluetooth function, and a personal digital assistant (PDA), etc.

Moreover, the disclosed method(s) may also be implemented as a computer program that is executed by processor(s) (such as a CPU) in a mobile terminal and is stored in a storage device of the mobile terminal. When the computer program is executed by the processor(s), the aforementioned functions defined in the method(s) of the present disclosure are executed.

Moreover, the disclosed method(s) may also be implemented as a computer program product. The computer program product may include a computer readable medium, and the computer readable medium may store a computer program that is used for executing the above functions as defined in the method(s) of the present disclosure.

Moreover, the method blocks and the system units as described above may also be implemented using a controller and a computer readable storage device configured to store a computer program that enables the controller to implement the above method blocks or functions of the units.

One skilled in the art should further understand that the various exemplary logic blocks, modules, circuits and algorithm procedures disclosed herein may be implemented in form of an electronic hardware, a computer software, or a combination thereof. In order to clearly describe the interchangeability of hardware and software, a general description has been provided for functions of various schematic assemblies, blocks, modules, circuits and method procedures. Whether a function is implemented as software or hardware depends on a specific application and design constraints that are applied to an entire system. One skilled in the art may implement the functions in a variety of different manners for each specific application. However, such implementations should not be construed as departing from the scope of the present disclosure.

Although the exemplary embodiments of the present disclosure have been disclosed in the foregoing content, it should be noted that a variety of changes and modifications may be made without departing from the scope of the appended claims of the present disclosure. The functions, method blocks and/or actions of the method claims of the inventive embodiments described herein do not need to be executed in any particular order. Moreover, an element of the present disclosure can be described or needed individually, but may exist as multiple entities, unless clearly specified as a single entity.

Although the embodiments of the present disclosure are described with reference to the accompanying drawings, one skilled in the art should understand that various types of improvements may also be made to the embodiments provided in the present disclosure without departing from the content of the present disclosure.

Professionals may further recognize that the units and algorithm procedures of the examples described in the embodiments that are disclosed in this specification can be implemented in form of an electronic hardware, a computer software, or a combination thereof. In order to clearly describe the interchangeability of hardware and software, a general description has been provided for functions of various schematic assemblies, blocks, modules, circuits and method procedures. Whether a function is implemented as software or hardware depends on a specific application and design constraints that are applied to an entire system. One skilled in the art may implement the functions in a variety of different manners for each specific application. However, such implementations should not be construed as departing from the scope of the present disclosure.

Procedures of the methods or algorithms described in the disclosed embodiments of this specification may be implemented in form of hardware, a software module executed by a processor, or a combination thereof. The software module may be placed in random access memory (RAM), memory, read only memory (ROM), an electrically programmable ROM, an electrically erasable programmable ROM, a register, a hard disk, a movable disk, a CD-ROM, or any other form of storage medium that is well-known in the art.

The objectives, technical solutions and beneficial effects of the present disclosure are described in further details using the foregoing exemplary implementations. It should be noted that the above description merely represents exemplary implementations of the present disclosure, and is not intended to limit the scope of protection of the present disclosure. Any modifications, equivalent replacements and improvements made without departing from the spirit and principle of the present disclosure shall fall within the scope of protection of the present disclosure.

1. A method comprising:
generating a mask layer on a region of a page that is currently displayed in a screen of a mobile terminal according to a designated trigger instruction;
obtaining input information from a user on the mask layer;
determining dial information based at least in part on the input information; and
performing a dialing based at least in part on the dial information.

2. The method of claim 1, wherein the mask layer includes a div layer, and the div layer covers at least a portion of the region of the page that is currently displayed.

3. The method of claim 1, wherein performing the dialing comprises:
invoking a dialing program interface; and
sending the dial information to the dialing program interface for performing the dialing.

4. The method of claim 1, wherein generating the mask layer comprises setting at least a portion of the region of the page to be visible.

5. The method of claim 1, wherein the designated trigger instruction comprises a set function key of the mobile terminal being pressed for a set time length.

6. The method of claim 1, wherein obtaining the input information comprises receiving handwriting input content on the mask layer, and wherein determining the dial information comprises invoking a handwriting recognition program to recognize the handwriting input content to obtain the dial information.

7. The method of claim 1, wherein obtaining the input information comprises displaying numerical symbols on the mask layer and receiving clicks on the numerical symbols on the mask layer, and wherein determining the dial information comprises obtaining the dial information based at least in part on the clicks on the numerical symbols.

8. The method of claim 1, wherein obtaining the input information comprises displaying a dial interface on the mask layer and receiving clicks on numerical symbols of the dial interface, wherein the dial interface covers at least a portion of the region of the page that is currently displayed, and wherein determining the dial information comprises obtaining the dial information based at least in part on the clicks on the numerical symbols.

9. The method of claim 1, wherein generating the mask layer further comprises generating and displaying a dial button.

10. The method of claim 1, wherein generating the mask layer further comprises displaying content that prompts for inputting one or more numerals for performing the dialing.

11. The method of claim 1, wherein the mask layer comprises a transparent or semi-transparent layer.

12. An apparatus comprising:
one or more processors;
memory;
a generation unit stored in the memory and executable by the one or more processors to generate a transparent or semitransparent mask layer on a region of a currently displayed according to a designated trigger instruction;
an information acquisition unit stored in the memory and executable by the one or more processors to obtain input information from a user on the mask layer that is generated by the generation unit;
an information determination unit stored in the memory and executable by the one or more processors to determine dial information based at least in part on the input information that is obtained by the information acquisition unit; and
a dial unit stored in the memory and executable by the one or more processors to perform a dialing based at least in part on the dial information that is determined by the information determination unit.

13. The apparatus of claim 12, wherein at least a portion of the region of the page is set to be visible when the generation unit generates the transparent or semitransparent mask layer on the region of the currently displayed page according to the designated trigger instruction.

14. The apparatus of claim 12, wherein:
the information acquisition unit comprises a first acquisition unit to receive handwriting input content on the mask layer, and the information determination unit comprises a first determination unit to invoke a handwriting recognition program to recognize the handwriting input content to obtain the dial information;
the information acquisition unit comprises a second acquisition unit to receive multiple clicks on multiple numerical symbols on the mask layer after the multiple numerical symbols are displayed on the mask layer, and the information determination unit comprises a second determination unit to obtain the dial information based at least in part on the multiple clicks on the multiple numerical symbols; or
the information acquisition unit comprises a third acquisition unit to receive a plurality of clicks on a plurality of numerical symbols on a dial interface after the dial interface invoked by a set interface is displayed on the mask layer, wherein the dial interface covers at least a portion of the region of the currently displayed page, and the information determination unit comprises a third determination unit to obtain the dial information based at least in part on the plurality of clicks on the plurality of numerical symbols.

15. The apparatus of claim 12, further comprising a dial prompt unit to generate and display a dial button on the mask layer.

16. The apparatus of claim 12, further comprising a content prompt unit to display on the mask layer content that prompts for inputting numerals for performing the dialing, and/or cancel displaying of the content that prompts for inputting the numerals for performing the dialing.

17. One or more computer-readable media storing executable instructions that, when executed by one or more processors of a mobile terminal, cause the one or more processors to perform acts comprising:
generating a mask layer on a region of a page that is currently displayed in a screen of the mobile terminal according to a designated trigger instruction;
obtaining input information from a user on the mask layer;
determining dial information based at least in part on the input information; and
performing a dialing based at least in part on the dial information.

18. The one or more computer-readable media of claim 17, wherein performing the dialing comprises:
invoking a dialing program interface; and
sending the dial information to the dialing program interface for performing the dialing.

19. The one or more computer-readable media of claim 17, wherein generating the mask layer comprises setting at least a portion of the region of the page to be visible.

20. The one or more computer-readable media of claim 17, wherein generating the mask layer further comprises:
generating and displaying a dial button; and
displaying content that prompts for inputting one or more numerals for performing the dialing.
